(19) United States
(12) Patent Application Publication
(10) Pub. No.: US 2005/0006962 A1
(43) Pub. Date: Jan. 13, 2005

(54) Rotational balance structure for motor

(75) Inventor: Alex Horng, Kaohsiung (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung (TW)

(21) Appl. No.: 10/885,779

(22) Filed: Jul. 8, 2004

(30) Foreign Application Priority Data
Jul. 9, 2003 (TW) 92212607

(51) Int. Cl. H02K 5/24; H02K 1/22

(52) U.S. Cl. 310/51

(57) ABSTRACT

A motor includes a base, a stator mounted on the base, a rotor having a bottom end face, a metal ring mounted to the bottom end face of the rotor, and a balancing magnetic ring. The stator creates alternating magnetic fields when energized. A ring magnet is securely mounted to the rotor. The alternating magnetic fields drive the ring magnet and the rotor to turn. The balancing magnetic ring is mounted on the base and faces the metal ring. The balancing magnetic ring continuously attracts the metal ring when the rotor turns, thereby maintaining rotational balance of the rotor.

### BACKGROUND OF THE INVENTION

1. Field of the Invention

The present invention relates to a rotational balance structure for a motor. In particular, the present invention relates to a motor with improved rotational balance for the rotor of the motor.

2. Description of Related Art

FIG. 1 of the drawings illustrates a conventional heat-dissipating fan motor comprising a rotor 1, a stator 2, a base 3, and a balancing ring 4. The rotor 1 includes a rotor housing 11, a shaft 12, and a ring magnet 13. The stator 2 includes a core 21 and a winding 22. The base 3 includes an axial tube 31 and a bearing 32. The stator 2 and the balancing ring 4 are mounted around an outer periphery of the axial tube 31, and the shaft 12 is rotatably extended through the bearing 32. The balancing ring 4 is made of a magnetically conductive material such as iron or iron alloy. The ring magnetic 13 on the rotor 1 is driven by the alternating magnetic fields created by the stator 2 when supplied with electricity, thereby driving the rotor 1 to turn. Meanwhile, the ring magnet 13 attracts the balancing ring 4 to maintain rotational balance of the rotor 1. Such a motor structure has been disclosed in many patents, such as U.S. Pat. Nos. 6,097,120; 6,050,785; 6,290,471; 6,386,837; and 6,483,209.

Although the magnetic attractive force between the balancing plate 4 and the annular magnet 3 may maintain rotational balance of the rotor 1, this magnetic attractive force also causes dispersion of a portion of magnetic flux of the ring magnet 13. In other words, rotational balance is obtained at the cost of magnetic leakage in the ring magnet 13. The greater the induction area between the balancing ring 4 and the ring magnet 13, the larger the magnetic leakage. Since not all of the magnetic flux of the ring magnet 13 is used to alternately energize the stator 2, the rotational speed and the torque of the rotor 1 are noticeably reduced due to provision of the balancing ring 4.

### OBJECTS OF THE INVENTION

An object of the present invention is to provide a rotational balance structure for a motor to provide the required balancing effect for the rotor without causing magnetic leakage.

Another object of the present invention is to provide a rotational balance structure for a motor with improved rotational balance.

A further object of the present invention is to provide a rotational balance structure for a motor to prolong the life of the motor.

### SUMMARY OF THE INVENTION

In accordance with an aspect of the present invention, a motor comprises a base, a stator mounted on the base, a rotor including a bottom end face, a metal ring mounted to the bottom end face of the rotor, and a balancing magnetic ring. The stator creates alternating magnetic fields when energized. A ring magnet is securely mounted to the rotor. The alternating magnetic fields drive the ring magnet and the rotor to turn. The balancing magnetic ring is mounted on the base and faces the metal ring. The balancing magnetic ring continuously attracts the metal ring when the rotor turns, thereby maintaining rotational balance of the rotor.

In an embodiment of the invention, the rotor includes a rotor housing and a metal sleeve. The ring magnet is mounted on the rotor housing, and the metal sleeve is securely mounted between the rotor housing and the ring magnet. The metal ring extends radially outward from a bottom end face of the metal sleeve.

The metal ring and the balancing magnetic ring are made of a magnetically conductive material.

In another embodiment of the invention, the balancing magnetic ring includes a plurality of annularly spaced sections made of a magnetically conductive material. The sections are mounted on the base along an imaginary circle and face an underside of the metal ring.

In a further embodiment of the invention, the base includes a circuit board mounted thereon. The balancing magnetic ring includes a plurality of annularly spaced sections made of a magnetically conductive material. The sections are mounted on the circuit board along an imaginary circle and face an underside of the metal ring.

In accordance with another aspect of the present invention, a motor comprises a base, a stator mounted on the base, a rotor including a bottom end face, a metal ring securely mounted to the bottom end face of the rotor, and a balancing magnetic ring. A circuit board is mounted on the base. The stator creates alternating magnetic fields when energized. A ring magnet is securely mounted to the rotor. The alternating magnetic fields drive the ring magnet and the rotor to turn. A balancing magnetic ring is mounted on the circuit board and faces the metal ring. The balancing magnetic ring continuously attracts the metal ring when the rotor turns, thereby maintaining rotational balance of the rotor.

Other objects, advantages and novel features of this invention will become more apparent from the following detailed description when taken in conjunction with the accompanying drawings.

### BRIEF DESCRIPTION OF THE DRAWINGS

FIG. 1 is a sectional view of a conventional motor;

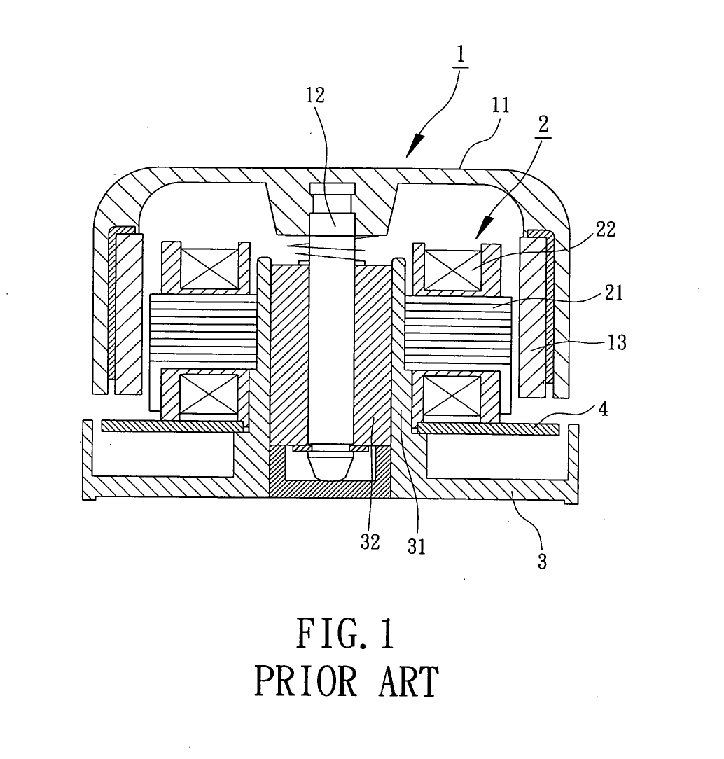

FIG. 2 is an exploded perspective view of a first embodiment of a motor in accordance with the present invention;

FIG. 3 is a sectional view of the motor in FIG. 2;

FIG. 4 is an exploded perspective view of a second embodiment of the motor in accordance with the present invention;

FIG. 5 is a sectional view of the motor in FIG. 4;

FIG. 6 is an exploded perspective view of a third embodiment of the motor in accordance with the present invention; and

FIG. 7 is an exploded perspective view of a fourth embodiment of the motor in accordance with the present invention.

### DETAILED DESCRIPTION OF THE PREFERRED EMBODIMENTS

Preferred embodiments of the present invention are now to be described hereinafter in detail, in which the same reference numerals are used in the preferred embodiments for the same parts as those in the prior art to avoid redundant description.

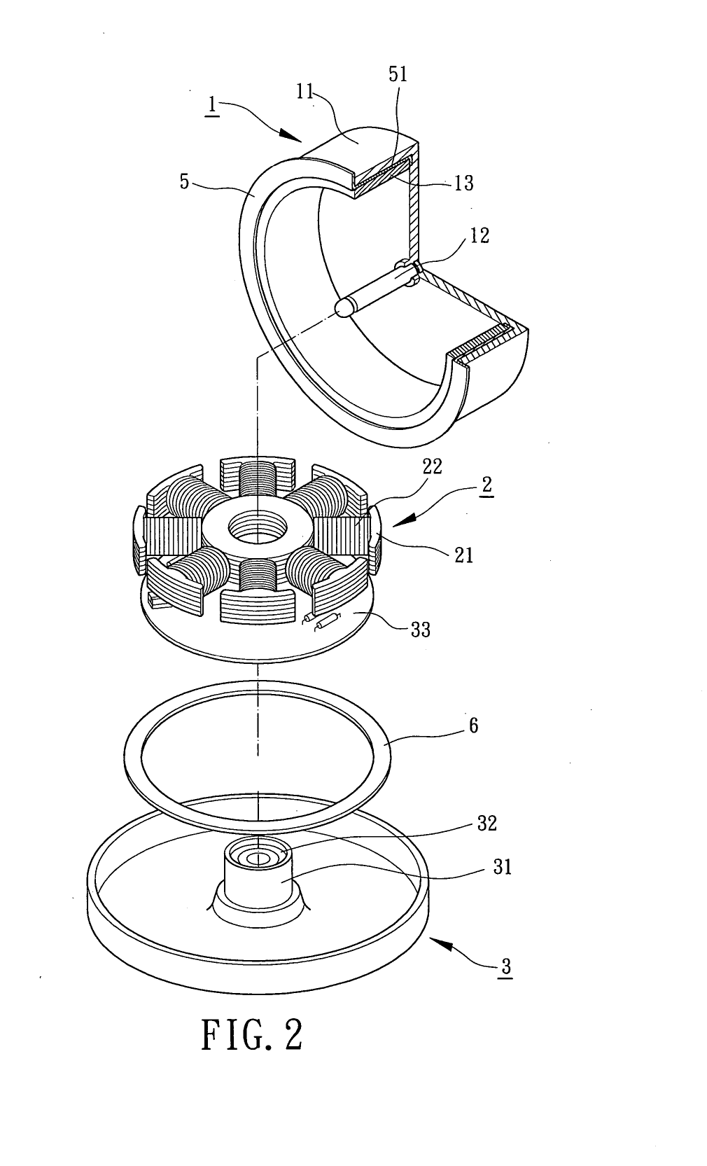

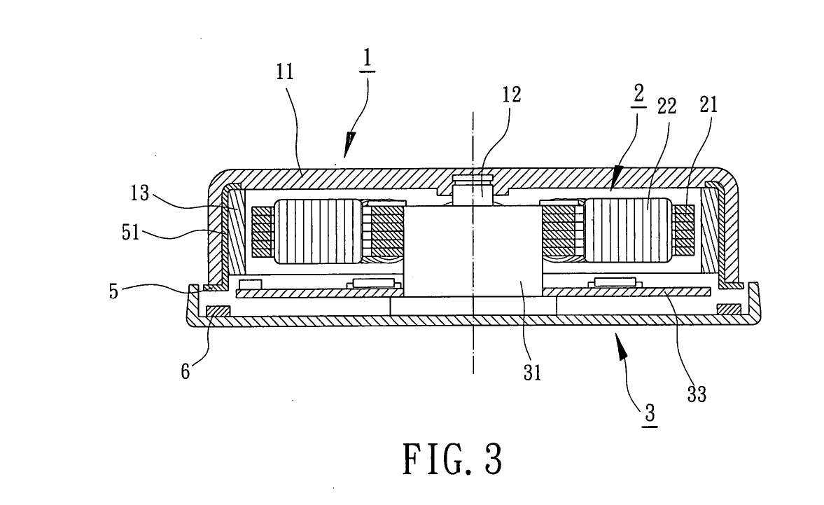

Referring to FIGS. 2 and 3, a first embodiment of a motor in accordance with the present invention comprises a rotor 1, a stator 2, a base 3, a metal ring 5, and a balancing magnetic ring 6. The rotor 1 includes a rotor housing 11, a shaft 12, a ring magnet 13, and a metal sleeve 51. The stator 2 includes a core 21 and a winding 22. The base 3 includes an axial tube 31, a bearing 32 mounted in the axial tube 31, and a circuit board 33 mounted around the axial tube 31.

The metal sleeve 51 is made of a magnetically conductive material, such as iron or iron alloy. The metal sleeve 51 is securely mounted between an inner periphery of the rotor housing 11 and the ring magnet 13, creating a magnetism-accumulating effect surrounding the ring magnet 13 and preventing magnetic leakage of the ring magnet 13. The metal ring 5 extends radially outward from a bottom end face of the metal sleeve 51 and beyond a bottom end face of the rotor housing 11. The balancing magnetic ring 6 is made of a magnetically conductive material and mounted to an appropriate position on the base 3 so that an upper face of the balancing magnetic ring 6 faces an underside of the metal ring 5.

As illustrated in FIG. 3, in assembly, the rotor l, the stator 2, and the circuit board 33 are mounted around the axial tube 31 of the base 3, with the balancing magnetic ring 6 being located outside the circuit board 33 of the base 3. Thus, the balancing magnetic ring 6 is not obstructed by the circuit board 33, assuring the upper face of the balancing magnetic ring 6 to face the underside of the metal ring 5.

When the ring magnet 13 on the rotor 1 is driven by the alternating magnetic fields created by the stator 2, the rotor 1 is driven to turn. Meanwhile, the balancing magnetic ring 6 continuously attracts the metal ring 5 on the rotor 1 to maintain rotational balance of the rotor 1. Magnetic leakage in the ring magnet 13 is avoided by the magnetic attraction between the balancing magnetic ring 6 and the metal ring 5. Thus, all of the magnetic flux of the ring magnet 13 can be used to induce and thus drive the rotor 1, assuring maximum rotational speed and maximum torque of the rotor 1.

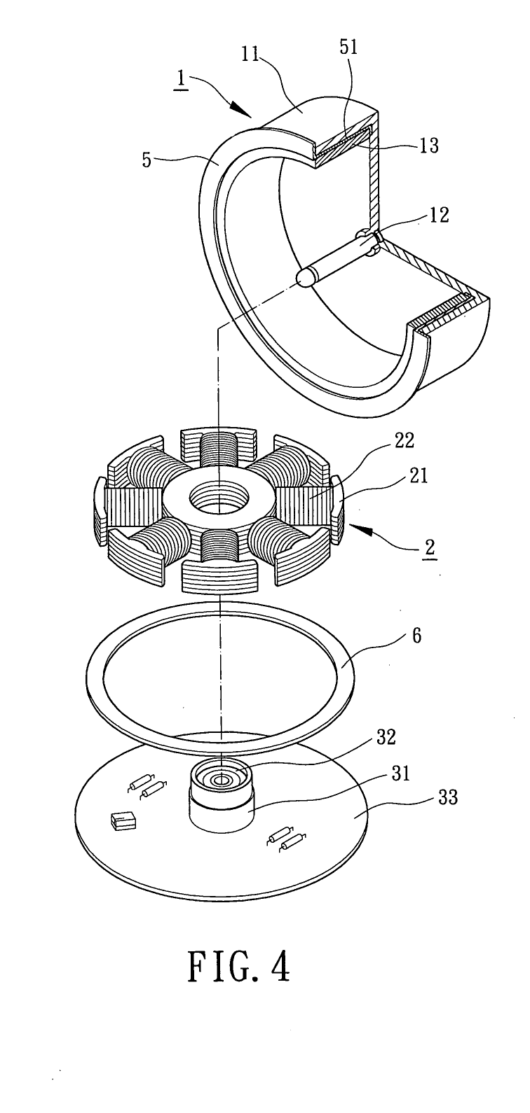

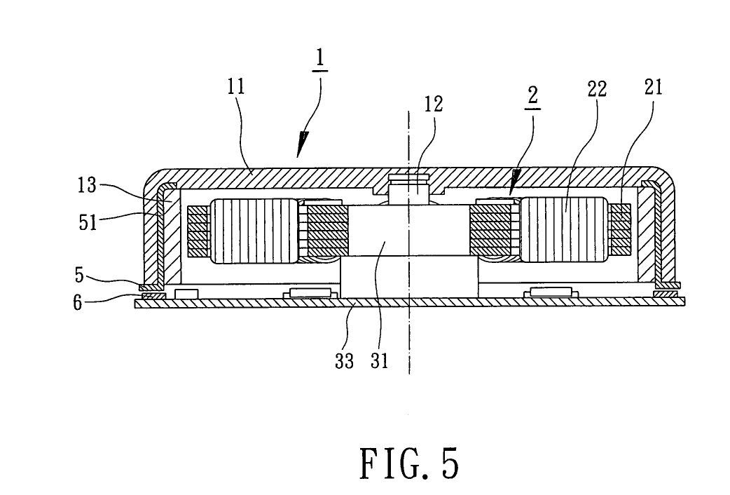

FIGS. 4 and 5 illustrate a second embodiment of the invention, wherein the balancing magnet ring 6 is mounted on the circuit board 33 of the base 3, with the upper face of the balancing magnet ring 6 facing the underside of the magnetic ring 5 on the rotor 1 to maintain rotational balance of the rotor 1, as the metal ring 5 will be attracted by the balancing magnetic ring 6. Thus, magnetic leakage in the ring magnet 13 is avoided, and maximum rotational speed and maximum torque of the rotor 1 are assured.

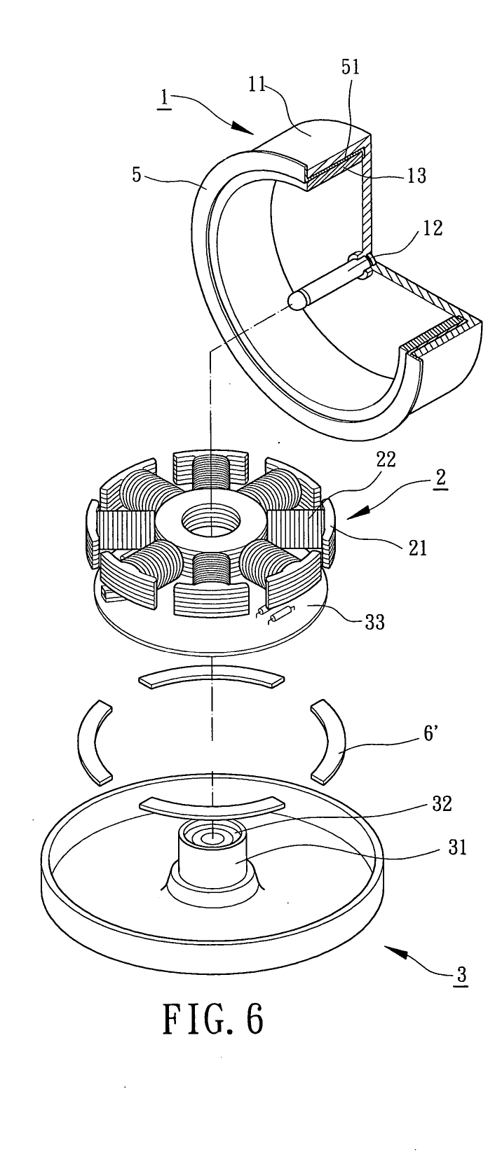

FIG. 6 illustrates a third embodiment of the invention, wherein the balancing magnetic ring (now designated by 6′) includes a plurality of annularly spaced sections made of a magnetically conductive material. The sections are symmetrically mounted on the base 3 or the circuit board 33 along an imaginary circle, with upper faces of the sections facing the underside of the metal ring 5 to maintain rotational balance of the rotor 1, as the metal ring 5 will be attracted by the sections constituting the balancing magnetic ring 6. Thus, magnetic leakage in the ring magnet 13 is avoided, and maximum rotational speed and maximum torque of the rotor 1 are assured.

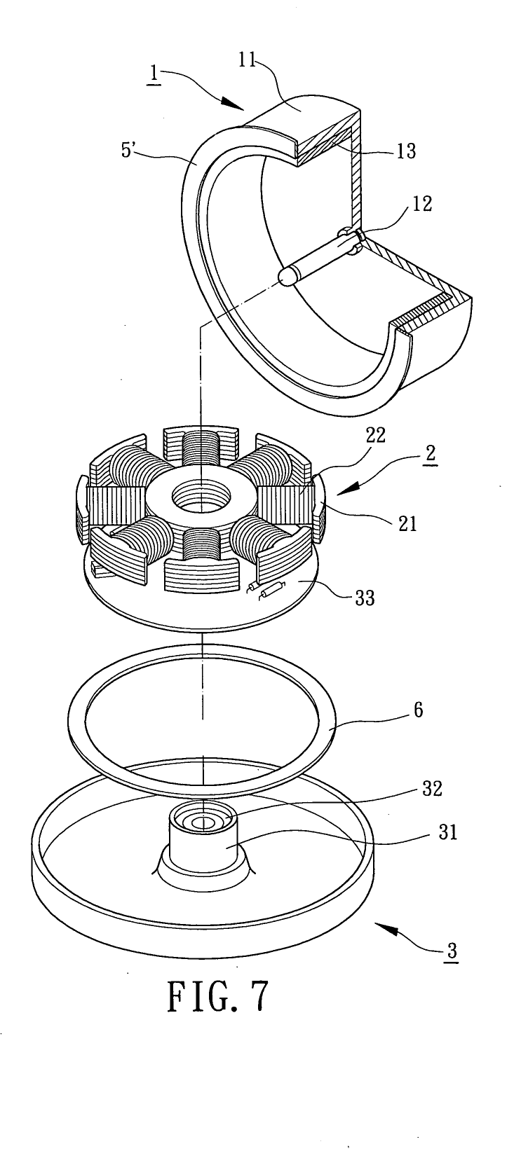

FIG. 7 illustrates a fourth embodiment of the invention, wherein the metal sleeve 51 in the above embodiments is omitted. Instead, the metal ring (now designated by 5′) is a ring fixed to the bottom end face of the rotor housing 11 by gluing, snapping, screwing, etc. When the rotor 1 turns, the balancing magnetic ring 6 attracts the metal ring 5′ to maintain rotational balance of the rotor 1. Thus, magnetic leakage in the ring magnet 13 is avoided, and maximum rotational speed and maximum torque of the rotor 1 are assured.

As apparent from the foregoing, the motors in accordance with the present invention have improved rotational balance for the rotor 1 without causing magnetic leakage of the rotor 1 while prolonging the life of the motors.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

1. A motor comprising:
a base;
a stator mounted on the base, the stator creating alternating magnetic fields when energized;
a rotor including a bottom end face, a ring magnet being securely mounted to the rotor, the alternating magnetic fields driving the ring magnet and the rotor to turn;
a metal ring mounted to the bottom end face of the rotor; and
a balancing magnetic ring mounted on the base and facing the metal ring, the balancing magnetic ring continuously attracting the metal ring when the rotor turns, thereby maintaining rotational balance of the rotor.

2. The motor as claimed in claim 1, with the rotor including a rotor housing and a metal sleeve, with the ring magnet being mounted on the rotor housing, with the metal sleeve being securely mounted between the rotor housing and the ring magnet, and with the metal ring extending radially outward from a bottom end face of the metal sleeve.

3. The motor as claimed in claim 1, with the metal ring being made of a magnetically conductive material.

4. The motor as claimed in claim 1, with the balancing magnetic ring being made of a magnetically conductive material.

5. The motor as claimed in claim 1, with the balancing magnetic ring including a plurality of annularly spaced sections made of a magnetically conductive material, the sections being mounted on the base along an imaginary circle and facing an underside of the metal ring.

6. The motor as claimed in claim 1, with the base including a circuit board mounted thereon, with the balancing magnetic ring including a plurality of annularly spaced sections made of a magnetically conductive material, the sections being mounted on the circuit board along an imaginary circle and facing an underside of the metal ring.

7. A motor comprising:
a base, a circuit board being mounted on the base;
a stator mounted on the base, the stator creating alternating magnetic fields when energized;
a rotor including a bottom end face, a ring magnet being securely mounted to the rotor, the alternating magnetic fields driving the ring magnet and the rotor to turn;
a metal ring securely mounted to the bottom end face of the rotor; and
a balancing magnetic ring mounted on the circuit board and facing the metal ring, the balancing magnetic ring continuously attracting the metal ring when the rotor turns, thereby maintaining rotational balance of the rotor.

8. The motor as claimed in claim 7, with the rotor including a rotor housing and a metal sleeve, with the ring magnet being mounted on the rotor housing, with the metal sleeve being securely mounted between the rotor housing and the ring magnet, and with the metal ring extending radially outward from a bottom end face of the metal sleeve.

9. The motor as claimed in claim 7, with the metal ring being made of a magnetically conductive material.

10. The motor as claimed in claim 7, with the balancing magnetic ring being made of a magnetically conductive material.

11. The motor as claimed in claim 1, with the balancing magnetic ring including a plurality of annularly spaced sections made of a magnetically conductive material, the sections being mounted on the circuit board along an imaginary circle and facing an underside of the metal ring.
